(19) United States
(12) Patent Application Publication
(10) Pub. No.: US 2006/0287903 A1
(43) Pub. Date: Dec. 21, 2006

(54) Enterprise asset management system

(76) Inventor: David W. Heard, Coppell, TX (US)

Correspondence Address: WILSON SONSINI GOODRICH & ROSATI, 650 PAGE MILL ROAD, PALO ALTO, CA, 94304-1050, US

(21) Appl. No.: 11/153,958

(22) Filed: Jun. 15, 2005

(51) Int. Cl. G06Q 99/00; G05B 19/418; G06F 15/02; G06F 9/46

(52) U.S. Cl. 705/8; 705/1; 705/9

(57) ABSTRACT

An embodiment of the invention is directed to an electronic management system having a database having information regarding equipment held by a plurality of separately-owned equipment using entities. The system includes logic that determines equipment held by a respective equipment using entity. The system includes logic that stores the determined information regarding the equipment into the database, and determines whether respective items of equipment held by the equipment using entity should be retained or disposed of based on information in the database.

### CROSS-REFERENCE

This application is related to copending patent application for Enterprise Asset Management Methods and Systems, Ser. No. ______ [Attorney Docket No. 21661.701.201], invented by David W. Heard and filed concurrently herewith which is incorporated herein by reference in its entirety.

### BACKGROUND

Companies that own or rely on large-scale assemblages of electronic information, communication and control equipment (often comprising integrated systems or networks) to deliver goods and/or services to end users typically have large budgets allocated annually for the purpose of maintaining, servicing, and where necessary upgrading and expanding, these assemblages of equipment. Such situations arise, for example, in the management of public telecommunications networks (such as those of telephone companies and cellular operators), and of industrial control equipment. The cost of managing such large assemblages of equipment is large.

Companies which manage large scale operations of the kind discussed above include (but are not limited to) those which provided fixed or mobile telecommunications services, cable television companies; companies with multiple sites or branches and dedicated wide-area networks for the electronic transmission of voice, data and other digital media between sites; companies that rely on industrial control and monitoring equipment in their assembly or manufacturing plants, power generation and transmission plants, or other large scale industrial facilities.

There are strong pressures on these companies to reduce the substantial budgets allocated to the operation and maintenance of their installed networks; while nevertheless minimizing downtime and quality of service degradation episodes, which adversely affect revenues from end users. This is particularly the case for telecommunications and cable operators, for which electronic information, communication and control equipment accounts for a large part of the value of their fixed tangible assets.

Companies with extensive electronic equipment assets often carry out the procurement and warehousing activities for their ongoing equipment requirements through in-house staff or by relying on small contractors for installation/deinstallation and other services. The in-house, or even contractor staff, do not typically have an appreciation of the savings which can be realized from high-quality re-used equipment (i.e. refurbished, tested and given a warrantee by the service provider). And even when the staff are aware of the secondary equipment market, they are unlikely to be familiar with the types of purchasing strategies likely to secure the lowest prices for the required type and quality of equipment.

Many operators of public telecommunications networks have multiple warehouses of telecommunications equipment for spares and incremental buildouts, but this equipment is seldom catalogued comprehensively and to individual component level. As a result, these operators cannot verify with certainty whether the equipment requirements in one region can be met through equipment spares located at one of their own warehouses in another region of the country.

As can be seen from the above, there is a need for improved methods and systems for managing equipment assets held by the entities that use such assets.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

FIG. 1A is a block diagram of a system for managing equipment, according to an embodiment of the invention.

FIG. 1B is a high-level flow diagram of a suite of management processes and applications for management of electronic, information, communication, and control equipment assets, according to an embodiment of the invention.

FIG. 1C is a block diagram showing databases of a system for managing equipment along with the flow of data between these databases, according to an embodiment of the invention.

FIG. 2 is a flow diagram of determining equipment held by an equipment using entity, according to an embodiment of the invention.

FIG. 2a is block diagram regarding discrepancies in information regarding equipment held by an equipment using entity, according to an embodiment of the invention.

FIG. 2b is a flow diagram showing determining equipment held by an equipment using entity in particular related to a visit of the premises of the entity, according to an embodiment of the invention.

FIG. 3 is a flow diagram of sale of an item of equipment by a service provided to an equipment using entity, according to an embodiment of the invention.

FIG. 4 is a flow diagram of obtaining price information, according to an embodiment of the invention.

FIG. 5 is a flow diagram of price comparison analysis using price information, according to an embodiment of the invention.

FIG. 6 is a flow diagram of determining disposition of items of equipment, according to an embodiment of the invention.

FIG. 7 is a flow diagram of valuing equipment, according to an embodiment of the invention.

FIG. 8 is a flow diagram of payment, according to an embodiment of the invention.

FIG. 9 is a example of a screen display for showing equivalencies between equipment items, according to an embodiment of the invention.

FIG. 10 gives examples of the matrices which the ECS consists of and which are used to identify equivalences between equipment items, including items such as components and assemblies, of different hierarchical levels, according to an embodiment of the invention.

FIG. 11 is a flow diagram for showing determination of equivalencies and quantities of items of equipment, according to an embodiment of the invention.

FIG. 12 is a chart showing an example matrix of equivalencies between items of different hierarchical levels, according to an embodiment of the invention.

FIG. 13A describes the iterative process for optimizing re-used equipment purchases, according to an embodiment of the invention.

FIG. 13B is a data flow diagram showing databases of a system for managing equipment along with the flow of data between the databases for equipment purchasing, according to an embodiment of the invention.

### DETAILED DESCRIPTION

Embodiments of the inventions are directed to managing equipment held by equipment users on an outsourced basis. For example, embodiments of the invention are directed to managing, on an outsourced basis, equipment for a set of operators of public telecommunications networks and/or for operators of other large-scale electronic networks, such as industrial monitoring and control facilities.

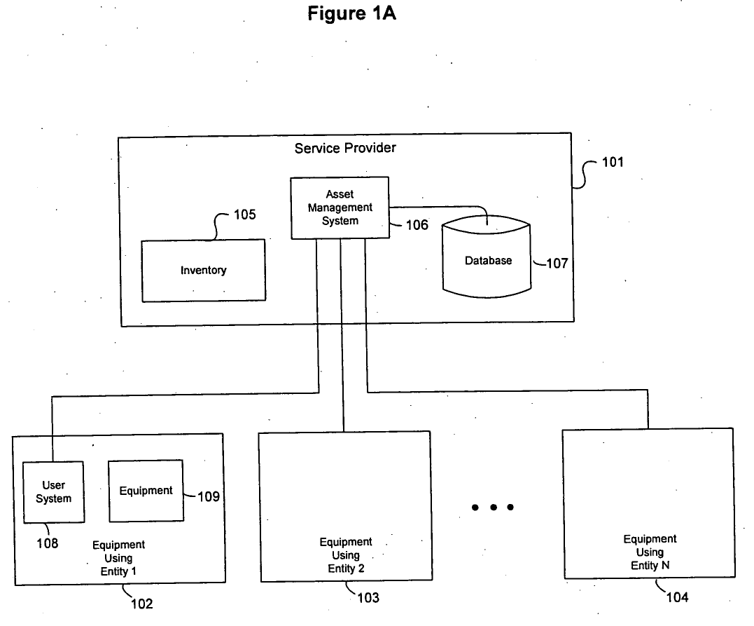

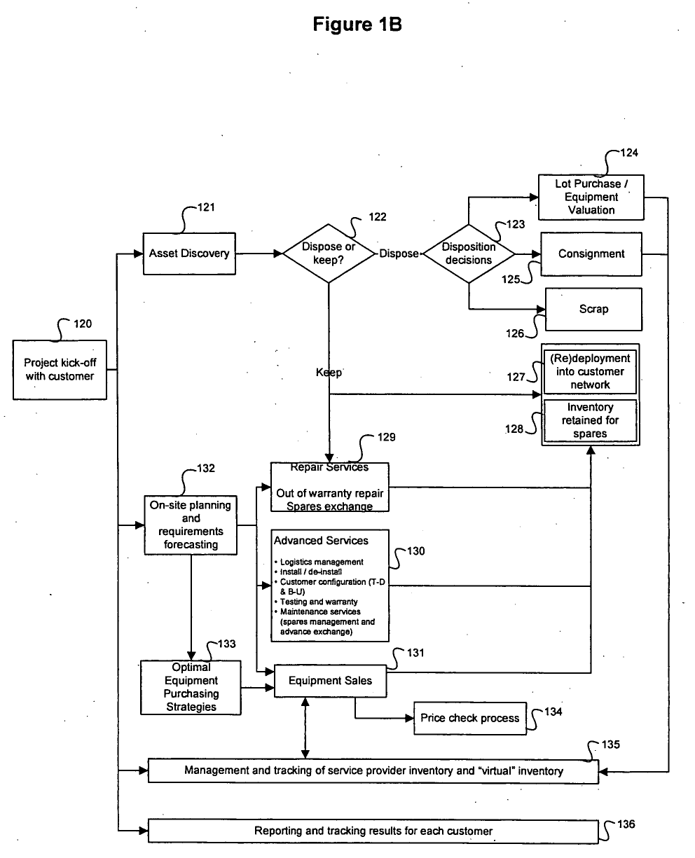

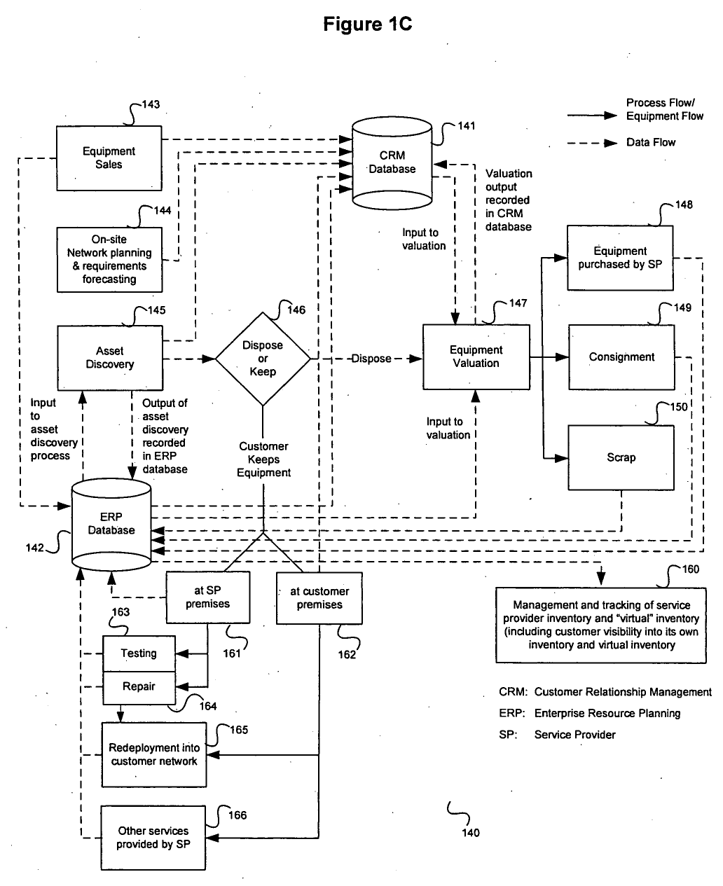

FIG. 1A is a block diagram of a system for managing equipment, according to an embodiment of the invention. Shown are service provider 101, equipment using entity 1 102, equipment using entity 2 103 and equipment using entity N 104. Service provider 101 has inventory 105, asset management system 106, and database 107. Equipment using entity 1 102 has user system 108 and equipment 105. Service provider 101 maintains asset management system 106 which helps service provider 101 to provide asset management services to various entities that use equipment such as the entities shown.

Database 107, which is in communication with asset management system 106, can contain various types of information, including assets used by various equipment using entity customers of service provider 101 as well as other information. The database 107 may include information regarding equipment held by the equipment using entities as well as information about the quantities, type and location of available secondary market equipment. Database 107 includes information regarding inventory 105 (including equipment held on consignment by the service provider), as well as records showing surplus equipment held by equipment using entities 1 through N. 1 through N may comprise various entities that use equipment managed by the methods and systems described herein. For example, such entities may be in various industries, such as the operators of public telecommunications networks (or entities in other industries). According to an embodiment of the invention, a plurality of entities within a single industry are managed, thereby facilitating exchange of assets among the entities. These entities that use equipment, “equipment using entities,” are sometimes referred to herein as “customers,” since they may be the customers of service provider 101. Thus, service provider 101 manages equipment of equipment using entities on an outsourced basis. For example, using asset management system 106, service provider 101 manages equipment held by equipment using entities 1 through N, such equipment including equipment 109, which is held by equipment using entity 1 102. The services described herein may be implemented in whole or in part by computer implemented software methods included within asset management system 106. The outsourced management may involve service provider 101 entering into a master agreement with the respective equipment using entities to provide some combination of the services described herein.

Note that database 107 may be implemented as a set of databases, according to an embodiment of the invention. For example, in one embodiment, database 107 includes an enterprise resource planning (ERP) database and a customer relationship management (CRM) database.

FIG. 1B is a high-level flow diagram of a suite of management processes and applications for managing equipment, according to an embodiment of the invention. The processes and applications applied by a service provider such as service provider 101 shown in FIG. 1A for customers who hold equipment such as equipment using 1 through N as also shown in FIG. 1A.

A project kick-off with a customer (block 120), which is typically an equipment using entity, may start the process. Various components of the suite of management processes and applications include combinations of asset discovery (block 121), on site planning and requirements forecasting (block 132), and optimal equipment purchasing strategies (block 133). Asset discovery involves determining assets held by the equipment using entity. This process may involve combinations of reviewing information maintained by the equipment using entity and/or visiting the premises (sometimes referred to as a site) of the equipment using entity to determine such asset and/or to reconcile the information provided by the entity with the information determined from the visit. Based on asset discovery, decisions are made regarding what to do with respect to equipment.

The equipment using entity may decide, after asset discovery (block 121), whether to dispose or keep (block 122) the respective item(s) of equipment. Under-utilized or surplus assets may be identified, analyzed and catalogued. The equipment using entity, such as a network operator, may select among various disposition decisions (block 123). Such decisions may include 1) dispose of the equipment through the secondary market (blocks 124 and 125), 2) scrap the equipment (block 126), for example, where it has negligible market value (or where the cost of refurbishment and resale is greater than the expected market value), 3) or redeploy the equipment elsewhere in the operator's network (block 127) and/or other decisions.

If a decision is made to keep the respective items of equipment, the items would continue to be deployed or re-deployed into the equipment using entity's network (block 127), retained as inventory for spares (block 128) or further utilized, such as after repair, such as provided through repair services (block 129).

The service provider may undertake planning and forecasting of equipment and service requirements for equipment using entities (block 132). Visits to the premises of the equipment using entity may be involved to gain access to data about the equipment using entity's installed equipment base, the usage patterns for equipment spares, and the planned changes in the network's capacity (depending on traffic trends and the availability of capacity). On-site planning and requirements forecasting may result in recommendations for repair services (block 129), advanced services (block 130), equipment sales (block 131) and/or optimal equipment purchasing strategies (block 133).

The integrated suite of management processes and applications includes processes for the systematic analysis of equipment held by equipment using entities. For example, analysis may be performed on an equipment using entity's network or other population of equipment in order to identify under-utilized and excess equipment and other opportunities for optimization of populations of deployed and spare equipment and the ongoing capital outlay to maintain them (for example, replacing failed items).

Also included in the set of processes are management and tracking service provider inventory and virtual inventory (block 135) and reporting and tracking results for equipment holding entities (block 136). Management and tracking of service provider inventory and virtual inventory (block 135) helps to allow for the service provider to sell equipment (equipment sales block 131). Such equipment may be obtained by the service provider from equipment using entities (block 124), consignment (block 125), and/or through other sources.

Asset discovery may include visiting the premises of the equipment using entities, real-time logging of equipment items discovered during the visits, and reference to the entity's records of spare and deployed equipment (which may be imported into a database such as an ERP database) held by the service provider.

The integrated suite of management processes and applications includes processes for dealing with equipment items held by the service provider (either after a lot purchase, or held on behalf of the equipment using entity in a consignment program) which may be used for redeployment back into one or more of the network(s) owned by the same equipment using entity, or to be included in spare inventory held by the equipment using entity. This subset of processes is known as internal redeployment. The integrated suite of processes generates detailed information on the structure and configuration of the equipment using entity's network or other population of equipment items and thereby assists in identifying such opportunities. Redeploying equipment items may include various combinations of identifying, testing, shipping and tracking the items, installation services and the application and management of appropriate warranty conditions.

FIG. 1C is a block diagram showing databases of a system for managing equipment along with the flow of data between these databases, according to an embodiment of the invention. The system 140 includes an equipment using customer relationship management (CRM) database 141, an enterprise resource planning (ERP) database 142 and various logical elements represented by the other elements shown, which can be implemented in various combinations of hardware and software. System 140 provides an electronic system for asset discovery, equipment valuation, disposition and internal redeployment activities.

System 140 includes logic to manage equipment sales 143, on-site network planning and requirements forecasting 144, asset discovery 145, dispose or keep decisions 146, equipment using entity keeping assets at the service provider's premises 161 or at the entity's own premises 162, testing 163, repair 164, redeployment into the customer's network 165, other services 166, equipment valuation 147, equipment purchase by the service provider 148, consignment 149, scrap 150, and management of inventory 160. The logic may be implemented in various combinations of hardware, software, and human activity. In one embodiment, for example, a computer system implements the various functions of system 140.

CRM database 141 contains data organized on an equipment using entity-specific basis, including equipment purchases and sales by the equipment using entity, and other intelligence regarding the equipment installed in the equipment using entity's network(s), such as forecasts of equipment requirements for spares and new builds. ERP database 142 contains the details regarding the equipment held by the service provider in its own inventory (for example received through purchase, block 148), or on consignment for one or more equipment using entities—see block 149. This information may include the manufacturer part number, the condition of the equipment, its location and the cost of the equipment to the service provider. ERP database 142 also records relevant details about equipment and services sales made by the service provider (block 143), including prices, equipment sold, and delivery dates.

Other data inputs into CRM database 141 include sales quotes for equipment and services provided by the service provider (regardless of whether or not the transaction quote is accepted and the transaction is completed). Inputs also include a description of the equipment identified as a result of asset discovery (block 145) conducted for the equipment using entity (especially if this equipment is not brought under the control of the service provider and thereby entered into the ERP database), the results of any equipment valuations for the equipment using entity conducted by the service provider (block 147), and market intelligence obtained regarding the installed equipment base and maintenance, warehousing, repair, replacement capital expenditure and new capital expenditure requirements. There is also a regular (e.g. daily) exchange of data regarding details about ongoing and completed equipment and services transactions (i.e. sales by the service provider to the equipment using entity) between CRM database 141 and ERP database 142.

Asset discovery (block 145) undertaken by the service provider at an equipment using entity premises (site) uses data from ERP database 142. The data may include manufacturer identification codes in order to identify and code stranded equipment. The output from asset discovery activities, specifically the type, quantities and condition of the stranded equipment items identified, is then recorded in ERP database 142, particularly if the equipment is to be taken to a service provider site. If the equipment identified as a result of the asset discovery activities is not subject to the service provider's control, the appropriate market intelligence regarding this equipment is entered into CRM database 141. As a result, the service provider may in the future contact the equipment using entity in question if the need arises for this type of equipment and it cannot be found in the service provider's inventory.

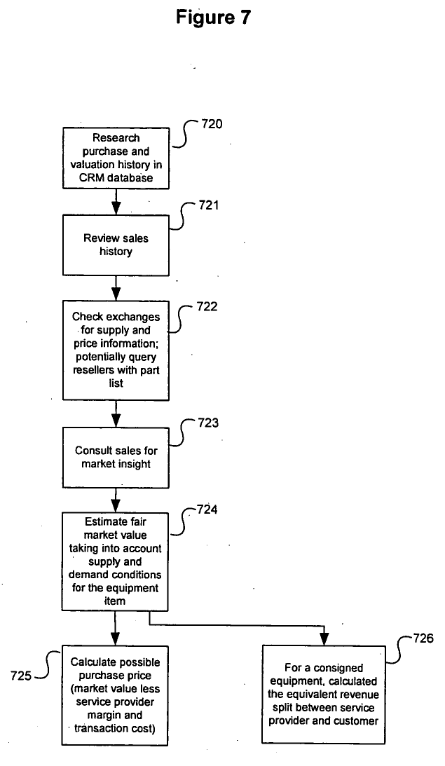

Once equipment is designated for disposition following asset discovery, a valuation of the equipment in question may be performed in order to assist in deciding how best to dispose of the equipment. FIG. 7 shows how valuation may be performed, according to various embodiments of the invention.

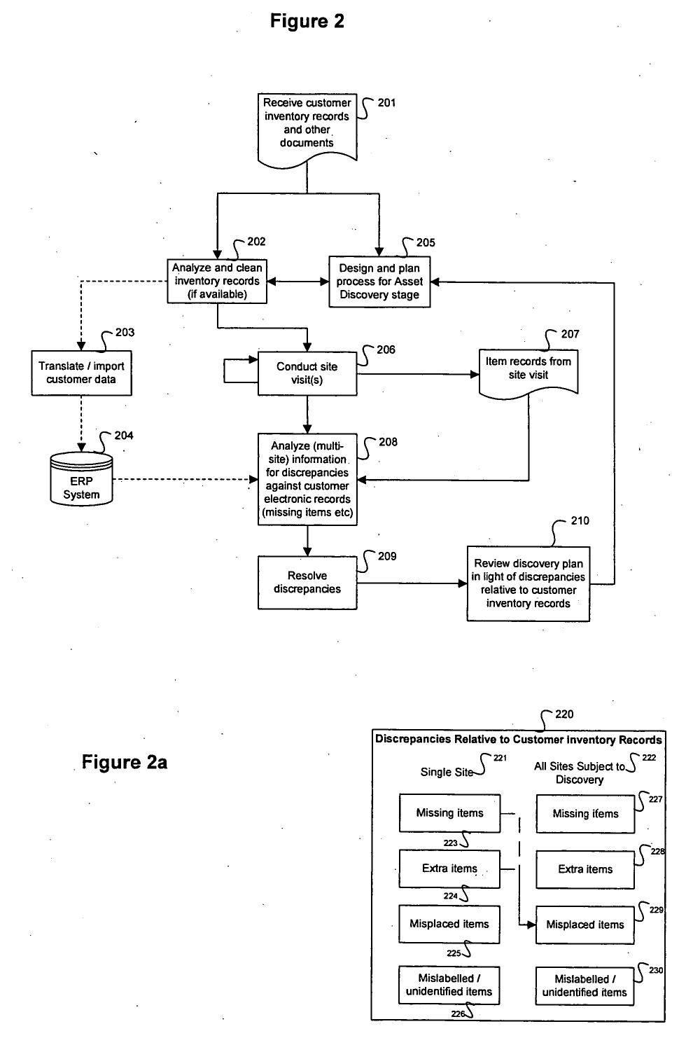

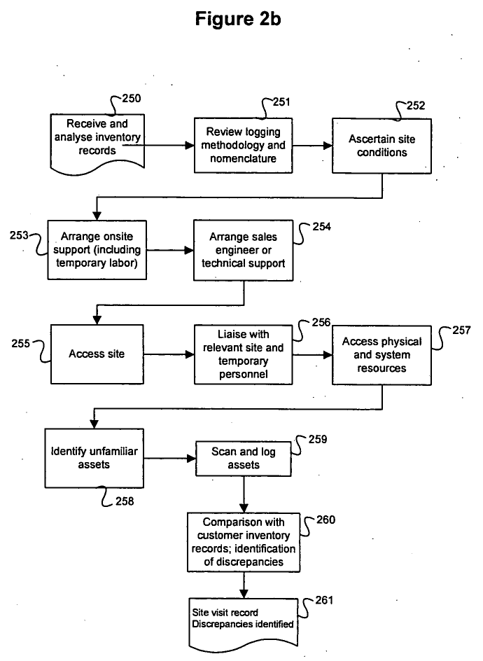

FIG. 2 is a flow diagram of determining equipment held by an equipment using entity, according to an embodiment of the invention. This is also known as asset discovery. The records may be stored in the database in a separate branch plant from that of the service provider's own inventory for comparison against the findings of physical site visits. Asset discovery involves an analysis of the equipment using entity's records of the equipment held, such as network assets or other equipment population including spare inventory. A premises visit program is designed based on the findings of this analysis. For example, where inventory records are incomplete, premises visits are scheduled in order to ascertain what equipment items are held by the equipment using entity. Where inventory records suggest that a certain quantity of items are unused and available for disposition, a premises visit could verify the presence and condition of the items. In order to facilitate comparison of the findings of the premises visit with the equipment using entity's inventory records, the records may be cleaned as necessary and optionally imported into a database maintained by the service provider. In this case the items recorded are neither owned by the service provider nor made available for sale by the service provider on behalf of the equipment using entity, but recorded in the database system for the purpose of verification, potentially in real-time, by staff engaged on the premises who have access to those records through the service provider's information systems. The equipment item records are appropriately tagged so as to distinguish them from items owned by the service provider or owned by the equipment using entity but made available for sale by the service provider.

The discovery process can identify underutilized items and other opportunities for optimization of the set of assets held by an entity. Asset discovery further involves consolidating and analyzing the results of one or more premises visits (block 206), for example, any discrepancies from the equipment using entity's inventory records (block 208), and any shortages or surpluses of various equipment items. Records are created from the premises visit (block 207). The information analyzed and cleaned from inventory records is translated and imported as customer data (block 203) into a database 204, such as an ERP system maintained by the service provider. This information is used in the analysis of information for discrepancies against equipment using entity electronic records (block 208). Where missing or surplus items are identified, these discrepancies may be resolved (block 209) on visits to other sites. If it is established that the equipment using entity's inventory records are particularly accurate or inaccurate, the site visiting program may be adjusted in the light of this (blocks 210 and 205).

FIG. 2a is block diagram regarding discrepancies in information regarding equipment held by an equipment using entity, according to an embodiment of the invention. Different classes of discrepancies in records 220 may arise between information regarding equipment items encountered during site visits and wheat is expected according to inventory records of the entity. In particular apparent discrepancies in records 221 may be resolved by linking them with corresponding records 222 that have equivalent discrepancies identified during visits of other sites of the entity's premises. For example a missing item at one site and a surplus item at another effectively cancel each other out and become one overall discrepancy of the type misplaced item. Single site 221 has missing items 223, extra items 224, misplaced items 225, and mislabeled/unidentified items 226. Multiple sites subject to discovery 222 have missing items 227, extra items 228, misplaced items 229, and mislabeled/unidentified items 230. A correspondence is shown from missing items 223 and extra items 224 of the single site 221 to misplaced items 229 of the multiple sites subject to discovery 222.

FIG. 2b is a flow diagram showing determining equipment held by an equipment using entity in particular related to a visit of the premises of the entity, according to an embodiment of the invention. The visit may involve verifying the identify, location and condition of equipment items, which may or may not be listed in inventory records obtained from the equipment using entity.

The visit involves planning and securing access to the site (block 252) and other necessary resources such as temporary labor and information systems (blocks 253 and 254). The process also includes preparatory research into the nomenclature of the assets (block 251) which are expected to be found, using for example the extended code space described herein. The site is accessed (block 255), the relevant site and temporary personnel are listed with (block 256), and the physical system and resources are accessed (block 257). These resources are then used to identify and log equipment items discovered (block 259). If a comparison in real time with the expected equipment inventory (block 260) is possible (for example, if access to the service provider's information systems is possible and equipment using entity inventory records have been transferred to them), then any discrepancies, for example missing items, surplus or unexpected items, or items in worse condition than expected, may be identified quickly (block 261). If not, further analysis may be undertaken subsequent to the visit.

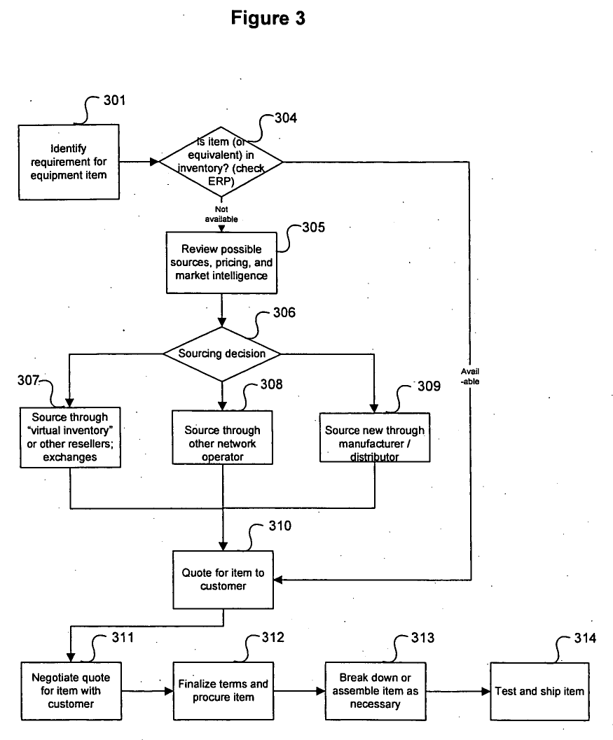

FIG. 3 is a flow diagram of sale of an item of equipment by a service provider to an equipment using entity, according to an embodiment of the invention. This includes supplying the equipment using entity with the item direct from the service provider's inventory, or sourcing it externally if it is not available in inventory.

First, a need for the respective equipment item is identified (block 301). If the item or the equivalent is available in inventory, as determined through a database maintained by the service provider such as an ERP database (block 304), then the item is quoted to the equipment using entity (block 310) based on such available item of equipment. After quoting the item, according to an embodiment, the following steps are taken, together in the order shown, alone, or in various combinations:

Negotiate quote for item with the equipment using entity (block 311);

Finalize terms and procure the respective item (block 312);

Break down or assemble the item as necessary (block 313); and

Test and ship the item (block 314).

If the item or equivalent is not available in inventory of the service provider based on a check of the service provider's database (block 304), then possible sources, pricing and market intelligence are reviewed (block 305). A decision as to how to source the equipment is made (block 306). Sourcing may be made through virtual inventory or other resellers or exchanges (block 307); through other network operators (block 308); or as a new item of equipment through a manufacturer or distributor (block 309). After such sourcing decision is made a quote for the item is made to the equipment using entity (block 310). After the quote has been made, the service provider proceeds as described above.

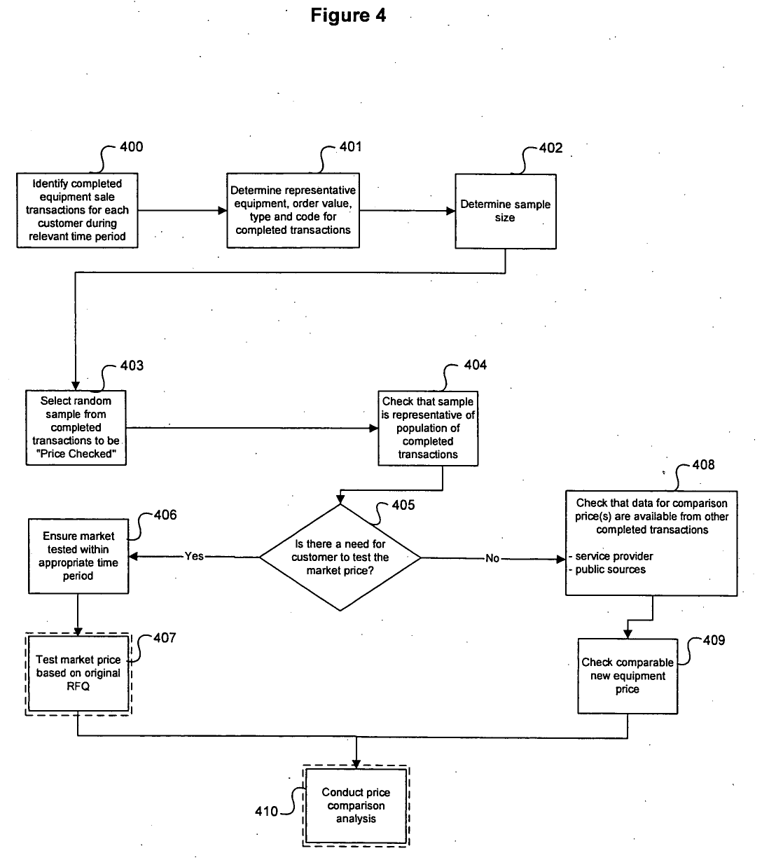

FIG. 4 is a flow diagram of obtaining price information, according to an embodiment of the invention. Price comparisons of equipment sales help to demonstrate the magnitude of the price savings which equipment using entities can secure through the service provider. According to an embodiment of the invention, results of the price comparison analysis are verifiable by a third party, auditors or independent reviewers.

The price check comparison analysis involves identifying completed equipment sales transactions for the equipment using entity during a relevant time period (block 400), identifying a representative sample of completed equipment sale transactions (block 401) and determining the appropriate data source for obtaining comparable prices to those of the completed transactions. These include other transactions completed by the same (or other) service providers which involve similar type of equipment and which are completed under similar market conditions, particularly during a similar period of time (for example during the same 2-week period as the original transaction). A sample size is defined (block 402), random sample is selected from the completed transactions for which the price is to be checked (block 403), and it is determined whether the sample is representative of the population of completed transactions (block 404).

It is determined whether there is a need for the equipment using entity to test the market price (block 405). Such a case would be where the price check or process cannot rely on data from comparable transactions completed during a similar time period. In such cases where the price check process cannot rely on data from comparable transactions completed during a similar time period, the price check process allows for the equipment using entity to test the market price for part or all (depending on the data requirements) of the original equipment order. This process of testing the market price is subject to guidelines regarding the information available to the equipment using entity contact person designated to conduct the market test. For example, it is ensured that the market is tested with the appropriate time period (block 406). The market price may be tested based on the original request for quotation (block 407).

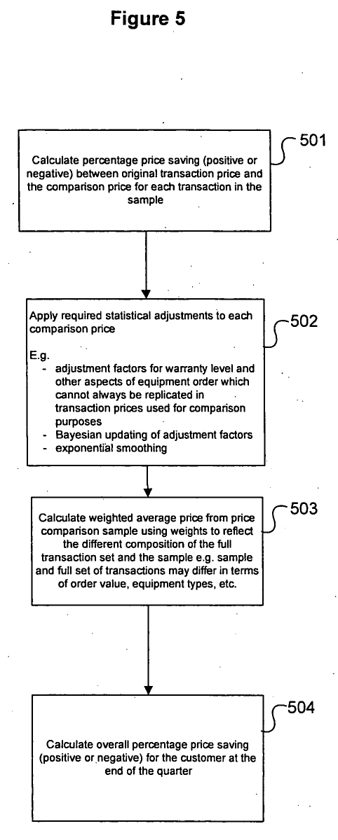

If there is not a need for the equipment using entity to test the market (the “no” branch of block 405), it is checked whether data for comparison prices are available from other completed transactions (block 408), such as data available from the service provider or public sources. Additionally, new comparable equipment price may be checked (block 409). Based on the obtained price data, a price comparison analysis is conducted (block 410) as shown further in FIG. 5.

FIG. 5 is a flow diagram of price comparison analysis using price information, according to an embodiment of the invention. Once sufficient data is obtained regarding comparable prices (multiple sources are possible), the price check process (starting at block 501) sets out each of the steps to calculate the percentage price saving achieved by the equipment using entity on the entire population of transactions completed during the pre-defined time period (for example, a quarter). This includes the appropriate statistical adjustments (block 502) which are applied to the raw price comparison data in order to generate price estimates which can be compared to those of the original equipment transactions. The price comparison data is input into a program, and statistical adjustment factors are applied (for example, to account for different warranty levels). The price savings results are automatically generated (block 503) and are then reported to the equipment using entity (block 504).

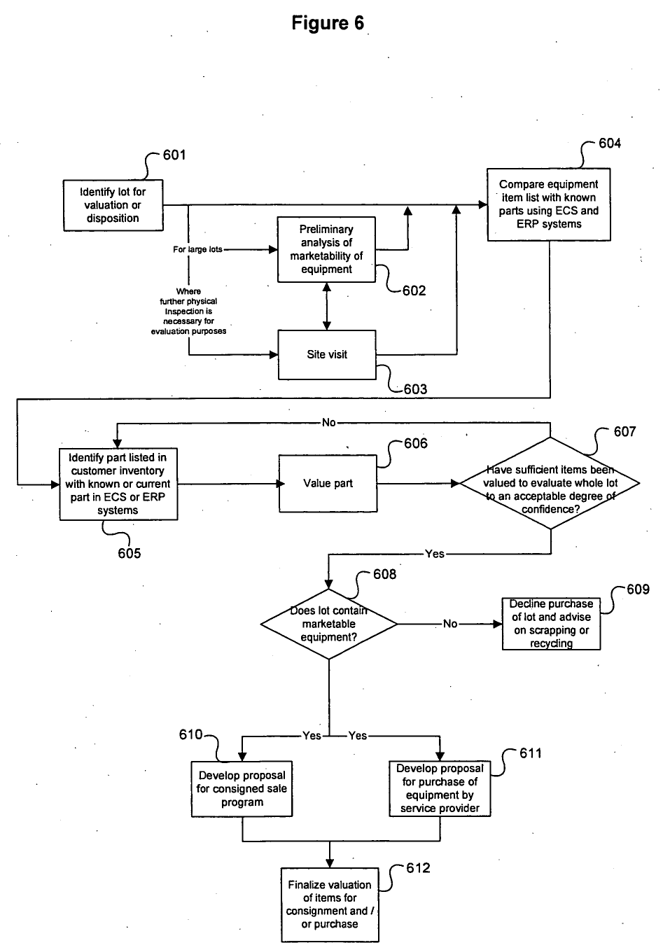

FIG. 6 is a flow diagram of determining disposition of items of equipment, according to an embodiment of the invention. Equipment held by the equipment using entity which is surplus to operational requirements is identified, and the most economically-efficient form of disposition of such equipment is selected. Programs to identify the optimal disposal method for equipment items (and lots of multiple items) which are identified as superfluous take account of (i) information on the equipment using entity's requirements (such as network expansion plans dictating that certain items should be retained, or a financial preference for trade credits against future purchases as a payment method) and (ii) information on the state of the market for particular equipment items which would determine their value and feasibility of sale. This information is recorded, updated and processed in various information systems. Alternative disposal methods include a lot purchase by the service provider, a consignment sale program executed on behalf of the equipment using entity by the service provider, and the scrapping or recycling of the equipment items in compliance with applicable environmental regulations. Items may be exchanged for other equipment supplied by the service provider, or payment terms may be settled in cash or by a trade credit against future purchases made from the service provider.

As shown, a lot is identified for evaluation or disposition (block 601). For large lots, preliminary analysis of marketability of the equipment is performed (block 602). Where further physical inspection is necessary for evaluation purpose, a premises visit is conducted (block 603).

The equipment item list is compared with known parts (block 604). The comparison is made using a computer system such as a ERP system with a database, and translation of codes referring to the respective equipment is made in order to determine equivalency of the equipment with other types of equipment whose identity is stored in the system. Accordingly, the parts listed are in the inventory of the equipment using entity identified as known as current parts in a system maintained by the service provider (block 605). The part is then valued (block 606). It is determined whether additional items have been valued to evaluate the whole lot to an acceptable degree of competence (block 607), and if solution items have not been valued, then return to block 605 to identify additional parts.

If sufficient items have been identified to evaluate the whole lot, it is determined whether the lot contains marketable equipment (block 608) and, if not, the offer to purchase the lot is declined and the equipment using entity is advised to scrap or recycle the equipment (block 609). If the lot does contain marketable equipment, then a proposal is developed for a consigned sale program (block 610) and/or a proposal is developed for purchase of the equipment by the service provide (block 611). Finally, evaluation of the items is finalized for consignment and/or purchase (block 612).

The integrated suite of management processes and applications embodies procedures to execute a consignment sale program, ongoing or of defined length on behalf of the equipment using entity. The equipment items become part of the provider's inventory (and are recorded and tracked in a database such as one maintained in the service provider's enterprise resource planning (ERP) system along with the provider's actual inventory, and tagged with appropriate codes used to distinguish the items from the inventory owned by the service provider) and are marketed accordingly.

The service provider then markets the items for sale on the re-used equipment market and internally on behalf of the equipment using entity. When items are sold, a proportion of the sale price is retained by the service provider as a fee for selling, and the remainder is credited to the equipment using entity. Items which are not sold may be scrapped or recycled at the end of the program, and items which are required and have not yet been sold may be withdrawn from the program and redeployed into the equipment using entity's network at any time. The consignment program can be used to generate cash from items which are not required, or a trade credit to contribute to purchases of other items through the service provider.

Where equipment items are either bought by the service provider (in a lot purchase) or made available for sale by the service provider on behalf of the equipment using entity in a consignment arrangement, the integrated suite of management processes and applications provide for alternative payment arrangements. Firstly, by negotiation with the service provider, an exchange may be made between the items sold and items which the equipment using entity would otherwise purchase from the service provider's inventory. Secondly, a formal trade credit account may be established, to which the value of items sold is credited and which may then be spent on further purchases from the service provider's inventory, or the provision of services. If the service provider bills the equipment using entity for a large quantity of goods or services, the trade credit can be deducted from any bill raised, for example on a monthly basis. In this way the equipment using entity can reduce the capital expenditure necessary to maintain or upgrade the network or other population of equipment. The integrated suite of management processes and applications includes processes for scrapping or recycling items which are not required and which are not marketable, either direct from the equipment using entity's site (warehouse or operating site) or from the service provider's site. Before scrapping or recycling equipment, the process includes a detailed review to ensure that the items designated for scrapping are definitely of no use, neither marketable nor suitable for repair. Since the service provider generally does not have the capability to scrap or recycle, a third party provider of these services is used, selected on their ability to deal with the equipment in question and provide the best possible value for it.

FIG. 7 is a flow diagram of valuing equipment, according to an embodiment of the invention. Data from an ERP database and CRM database in the system may be used to assess supply and demand for the respective equipment item. Additionally information from public exchanges for telecommunications equipment may be used to assess the supply and demand conditions for the respective equipment item according to an embodiment. The equipment valuation is done by making adjustment to historical transacted prices (i.e. historical market prices) based on changes in prospective supply and demand conditions for the equipment item(s) in question which have occurred since the historical prices were transacted.

Thus, equipment may be valued in part by researching purchase and valuation history for the equipment in the CRM database (block 720). Sales history is reviewed (block 721). Exchanges are checked for supplying price information, and resellers may be queried with a part list (block 722). A sales force or sales information may be consulted for information about the market for the equipment (block 723). An estimate is made for the fair market value, taking into account supply and demand conditions for the equipment item (block 724). A purchase price may be calculated (block 725), and this price may represent market value less a margin for the service provider and transaction cost. For consigned equipment, a revenue split between the service provider and the customer is calculated (block 726).

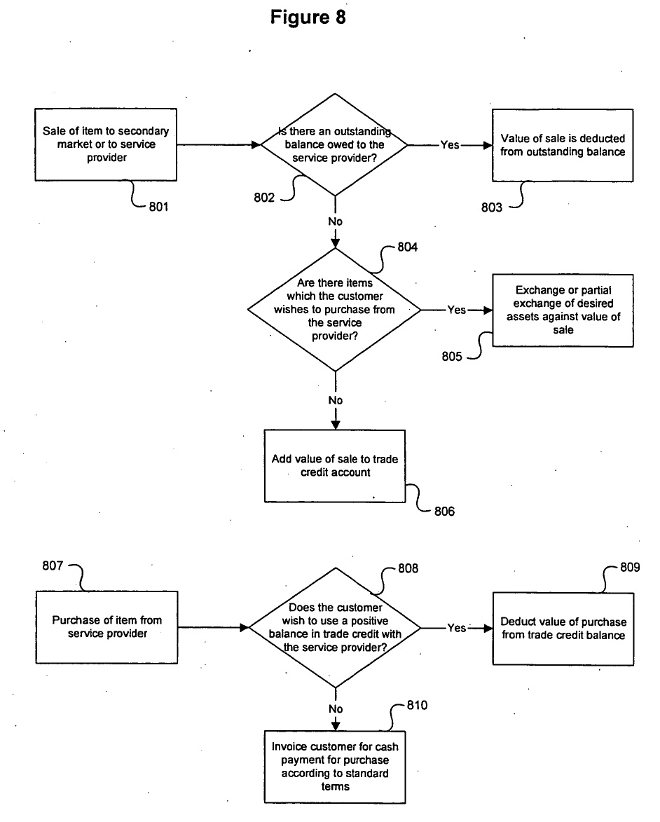

FIG. 8 is a flow diagram of payment, according to an embodiment of the invention. Various payment methods may be used by the service provider to credit the equipment using entity with proceeds from regular and consigned sales, scrapping and recycling. This includes cash payment, trade credit, and exchange. For example, if an item is sold to a secondary market or to the service provider (block 801), it is determined whether there is an outstanding balance owed to the service provider (block 802). If there is such an outstanding balance, the value of the sale is deducted from the outstanding balance (block 803). If there is not such an outstanding balance, it is determined whether there are items that the equipment using entity wishes to purchase from the service provider (block 804). If there are such items, the exchange or partial exchange of the desired assets is made against the value of the sale (block 805). If there are no such items which the equipment using entity wishes to purchase from the service provider, then the value of the sales is added to a trade credit account for the equipment using entity (block 806).

In another example, a purchase of an item is made from the service provider (block 807). It is determined whether the equipment using entity wishes to use a positive balance in the trade credit with the service provider (block 808). If so, the value of the purchase is deducted from the trade credit balance (block 809). If the equipment using entity does not wish to use such positive balance and trade credit with the service provider, an invoice is provided to the equipment using entity for cash payment for the purchase according to standard terms (block 810).

The integrated suite of management processes and applications enables its user to cost-effectively organize the provision of services to repair failed equipment items, involving (i) the use and development of in-house repair capabilities based on a systematic knowledge of the equipment using entity's network equipment and likely requirements, and (ii) the use and management of third party repair providers where in-house capabilities are not available. The choice between in-house (by the service provider) and third party repair provision is made by the service provider depending on the capabilities available and the equipment using entity's requirements, and the service is provided seamlessly to the equipment using entity regardless of this choice.

The integrated suite of management processes and applications helps to services to repair failed equipment items on behalf of the equipment using entity. This involves first deciding whether the equipment using entity's requirements can be met using in-house repair capabilities. Such capabilities may be developed over the medium term based on knowledge of the equipment using entity's network equipment and likely requirements. If the repair requirements cannot be met using in-house capabilities and these cannot be developed in a timely manner, a third party repair provider will be used. The choice between in-house (by the service provider) and third party repair provision is made by the service provider depending on the capabilities available and the equipment using entity's requirements, and the service is provided seamlessly to the equipment using entity regardless of this choice. If an equivalent item is available in the service provider's inventory and arrangements for exchanging items have been made with the equipment using entity, then a replacement item may be shipped to the equipment using entity while the failed item is repaired and returned to the service provider's own inventory (under an exchange arrangement). In either case, the repaired or replaced item will be tested before being shipped to the equipment using entity for installation.

The integrated suite of management processes and applications defines processes for delivering further advanced services, such as testing, installation, deinstallation, and custom configuration of equipment items, to manage and maintain an equipment using entity's network or other population of equipment items. This involves the use and development of in-house capabilities based on a systematic knowledge of the equipment using entity's equipment and likely requirements, and the use and management of third party service providers where in-house capabilities are not available.

According to an embodiment of the invention, reports are provided to the equipment using entity by the service provider. The following are selected metrics that may be included in such reports issued on various activities included in the suite of management processes and applications:

General Matters

Value of equipment population in scope of program

Proportion of population (in value and numerical terms) analyzed, verified, identified as underutilized

Value of equipment items purchased and redeployed; total savings achieved

Value realized from items not required; proportion of value channeled into purchases via equipment exchange and trade credit schemes

Discovery

Progress of discovery program including site visits

Identity, location and condition of equipment discovered

Accuracy of equipment using entity inventory records and discrepancies with equipment encountered

Underutilized, spare, and unexpected equipment items

Sales

Value of equipment items purchased; price check savings identified

Value of purchases under program in comparison with previous purchasing behavior

Tracked status of all equipment purchase requests/quotes

Proportion of sales settled using asset exchange and trade credit schemes; outstanding balances

Disposition

Value realized through all disposition channels

Tracked status (channel, progress, value realized) of all items marked for disposition

Lot Purchase

Value realized through purchase of items by service provider

Tracked status of items considered/marked for purchase

Consignment

Value realized through consigned sale of equipment items

Proportion of consigned lot successfully sold

Tracked status of items in consigned lot

Scrapping and Recycling

Value realized through scrapping and recycling

Documentation of scrapping and recycling including environmental compliance and data security

Tracked status of items and lots considered/marked for scrapping and recycling

Payment

Total value realized through disposition schemes

Amount settled in cash, through equipment exchange and in trade credits

Outstanding invoices, payments and balances

Repair/Advanced Services

Progress of repair and advanced services projects

Value and status of items marked for disposition and required for purchase

Equivalence

Equivalences identified including those between different hierarchical levels

Sourcing, break-down and assembly of equipment undertaken as a result of equivalences identified

Standardized procedures may be provided for tracking, reporting to the equipment using entity, and auditing the progress and financial results of the activities encompassed by the suite, over varying periods and for the program to date. The metrics which may be reported include those directly linked to specific activities in the overall program, such as the financial proceeds of a consignment sale program and the quantity of goods remaining to be sold, and those which may include more than one of these activities and which relate to the entire scope of the program for management of a network or other population of equipment. For example, across the entire network or all of the equipment population covered by the program, the total monetary value realized from equipment identified as surplus to requirements (and sold either to the service provider, or through a consignment program, or for scrapping or recycling). In addition the integrated suite of management processes and applications provides for detailed information on the progress of certain activities, for example lists of items remaining for sale under a consignment program, and transaction and technical reports (for example, test results) at the individual item level, to be made available through the service provider's ERP and CRM systems.

All of these metrics may be reported regularly over appropriate periods (for example, a four-week or one-month cycle), and for the program to date. The reporting processes also make available for operational purposes, although they represent a level of detail which may not be included in the top-level report, highly detailed information on progress of certain activities, for example lists of items remaining for sale under a consignment program, and transaction and technical reports (for example, test results) at the individual item level. The reports or database queries displaying this information are generated from or available in the service provider's ERP and CRM systems and allow equipment using entity personnel to maintain whatever visibility into the program is appropriate given their (for example, operational or executive) responsibilities and focus.

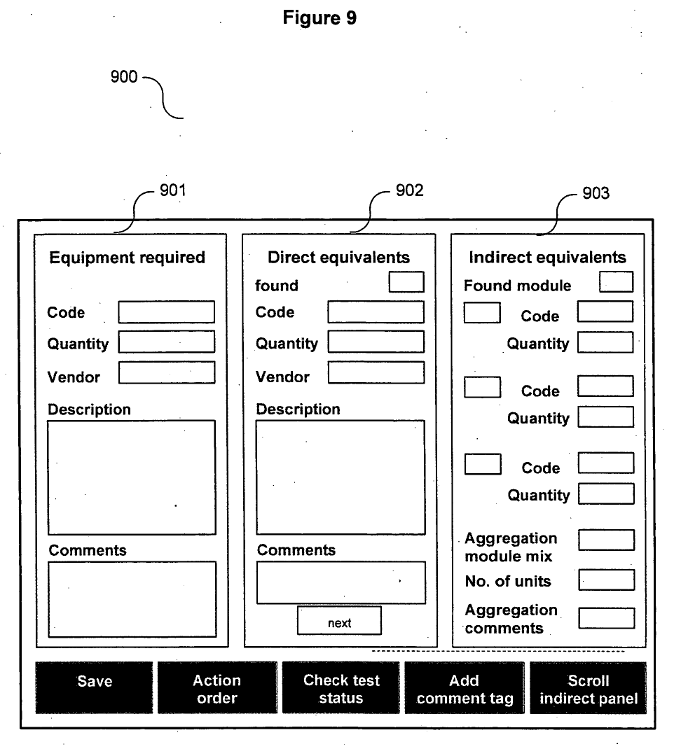

FIG. 9 is an example of a screen display for showing equivalencies between equipment items, according to an embodiment of the invention. A user who uses the aggregation and disaggregation capability may see screen display 900. For the case shown, there are three panels (901, 902 and 903) comprising the screen display (900). The employee enters the equipment type and quantity required into the left-hand panel (901). The extent to which this equipment is available from the equipment using entity's inventory without aggregation (assembly) or disaggregation (disassembly) is indicated, taking account of equivalences between equipment-type codes, in middle panel (902). The right-hand panel (903) shows the results returned by the automatic configuration logic module (ACLM) which show how the required equipment can be assembled from specific types and quantities of subordinate low-level equipment items (modules), such as circuit boards.

The integrated suite of management processes and applications provides for the recognition of reconfiguration and aggregation opportunities by establishing equivalencies between large numbers of low-level equipment items (for example, modules or circuit boards/cards), and higher-level equipment configurations (assemblies) and vice-versa. This ensures that low-level equipment items (for example, circuit boards) are not purchased unnecessarily when higher-level equipment configurations (assemblies) which contain those items are held in inventory, and the low-level equipment items can be obtained more cost-effectively by disassembling these higher-level equipment configurations (assemblies). Conversely the integrated suite of management processes and applications also ensures that high-level equipment configurations (assemblies) are not purchased unnecessarily when low-level equipment items which are already held in inventory can be assembled and tested to form the corresponding high-level equipment configurations (assemblies).

The equivalences principle is illustrated by the case of the multiplexers used in telecommunications networks for cost-effective combined transmission of numerous individual communication signals over the same transmission path. A multiplexer can be broken down into its constituent modules (for example, line modules, tributary modules, cross-connection matrix modules, processor modules); or complete multiplexers can be assembled from these modules.

The integrated suite of management processes and applications enables staff to systematically track equipment assets, including “virtual inventory” (i.e. inventory neither owned by the outsourced service provider nor held in the service provider's warehouse(s) under a consignment program for the sale of the inventory on behalf of the equipment using entity). Across multiple markets, vendors and user organizations the same equipment is often identified using different nomenclature and different short codes for identifying the same specific type of equipment item. Consequently, manipulation of identification codes for new and refurbished equipment taking account of such equivalences may be included in the integrated suite of management processes and applications. This enables tracking and identification of equipment in inventory and in virtual inventory, and optimum matching of this equipment to specific equipment requirements of the equipment using entity, taking account of equivalence between equipment identified by different codes, and providing the equipment using entity with visibility of the assets in service and those located in the warehouses. This is achieved using an extended code space (ECS). The ECS is a special-purpose database containing a large amount of detailed information on equivalences between pairs of equipment-type identification codes. This information is structured in the form of a matrix. This technique is used to represent detailed information on the equivalences between the numerous technically equivalent but different terms and codes used to identify electronic equipment, and to represent detailed information on the equivalences between high level equipment configurations (assemblies) and constituent modules.

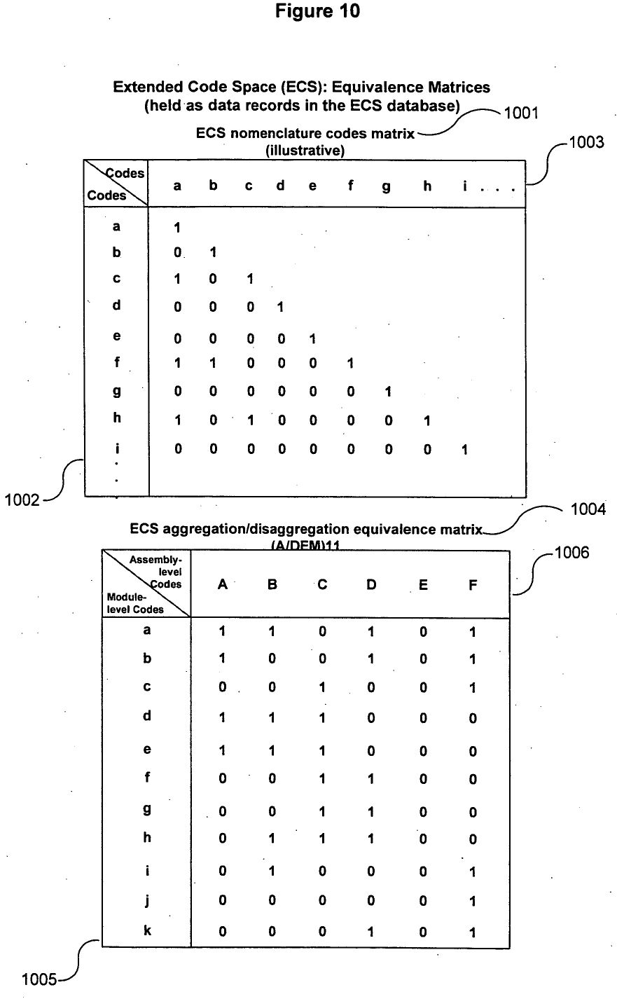

FIG. 10 gives examples of the matrices which the ECS consists of and which are used to identify equivalences between equipment items, including items such as components and assemblies, of different hierarchical levels, according to an embodiment of the invention. The information held in the extended code space (ECS) database is mainly recorded in the form of matrix. At least two distinct types of matrices may be stored in the ECS database according to an embodiment of the invention. These matrices are called equivalence matrices because they show (by means of “1” entries in the matrix) where two distinct codes or sets of codes represent equivalent equipment; and also (by means of “0” entries in the matrix) where two distinct codes or sets of codes do not represent equivalent equipment.

The first type is known as the ECS nomenclature codes matrix, and is illustrated as matrix 1001. All the equipment type codes in the database appear in both the rows and columns of the matrix, so the matrix has an equal number of rows and columns (it is a “square” matrix). The number along the diagonal is always “1” since every type of equipment designated by a code is equivalent to itself. Other entries in the matrix indicate whether any given pair of codes is or is not equivalent: for example, codes “a” and “b” are not equivalent, so the corresponding entry in the matrix is “0.” Codes “a” and “c” are equivalent, so the corresponding entry in the matrix is “1.”

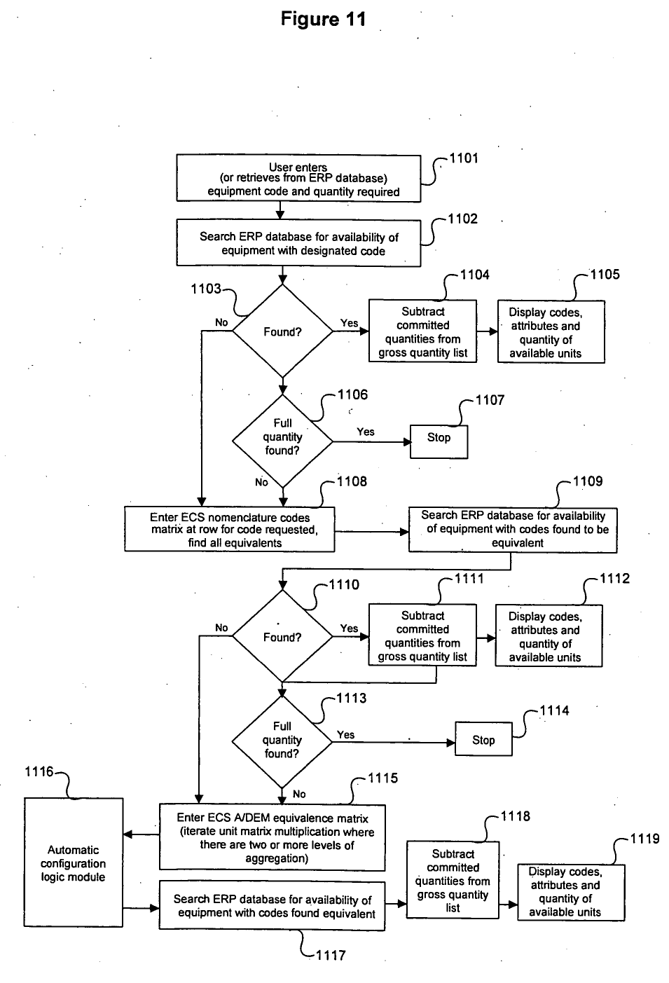

FIG. 11 is a flow diagram for showing determination of equivalencies and quantities of items of equipment, according to an embodiment of the invention. A staff member enters a requirement for a particular quantity of equipment units of a particular type (indicated by an equipment-type code (block 1101)). The service provider's database is searched for the availability of equipment with the designated code (block 1102). If the necessary quantity of equipment units of that type is found to be available in the equipment using entity's inventory (block 1103) (after taking account of the possibility that the relevant equipment might be identified by a different but equivalent code (block 1108 and 1 109)), the process then issues instructions for those equipment items to be deployed to meet the requirement and, the committed quantities are subtracted from the gross quantity (block 1 104), and the codes, attributes and quantity of the available units are displayed (block 1105). If the full quantity is found (block 1106), then the process is complete (block 1107).

If the necessary quantity of equipment units of that type is not found to be available in that way (block 1113), the integrated suite of management processes and applications then identifies whether the necessary quantity of equipment units of the relevant type can be obtained either by disassembling (“breaking down”) high-level equipment configurations (assemblies) which are available in the equipment using entity's inventory; or by assembling and testing sets of low-level equipment items (modules), such as circuit boards, already held in the equipment using entity's inventory to form the respective high-level equipment configurations (assemblies) (block 1115). The latter function is performed by an automatic configuration logic module (ACLM) (block 1116). Its operation is best illustrated by an example, drawn from telecommunications transmission equipment. If the equipment requirement is for a unit (an add-drop multiplexer or ADM) such as is used at intermediate points along a transmission route, and specifically an ADM of a particular type and a configuration providing for a given speed of transmission and a given number and speed of ports providing local access for communications traffic onto, and off, the transmission route, the ACLM automatically provides a list of the types and quantities of constituent modules (including racks and cabling as well as circuit boards) from which such a specific ADM can be assembled.

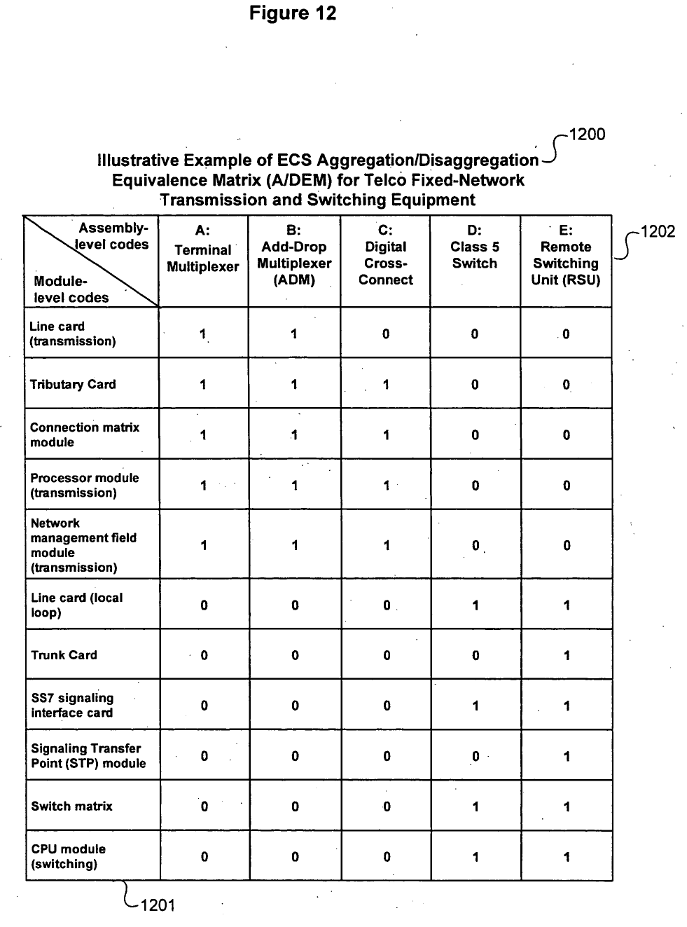

FIG. 12 is a chart showing an example matrix of equivalencies between items of different hierarchical levels, according to an embodiment of the invention. The second type of matrix included in the ECS database is known as the ECS aggregation/disaggregation equivalence matrix (A/DEM) 1200. Its rows correspond to codes for low-level equipment modules 1201 and its columns correspond to codes for higher level configurations (assemblies) 1202. Since there are more of the former than the latter, this is a rectangular, not square, matrix. As an example, transmission and switching equipment for telephone companies' fixed networks is shown in matrix 1200.

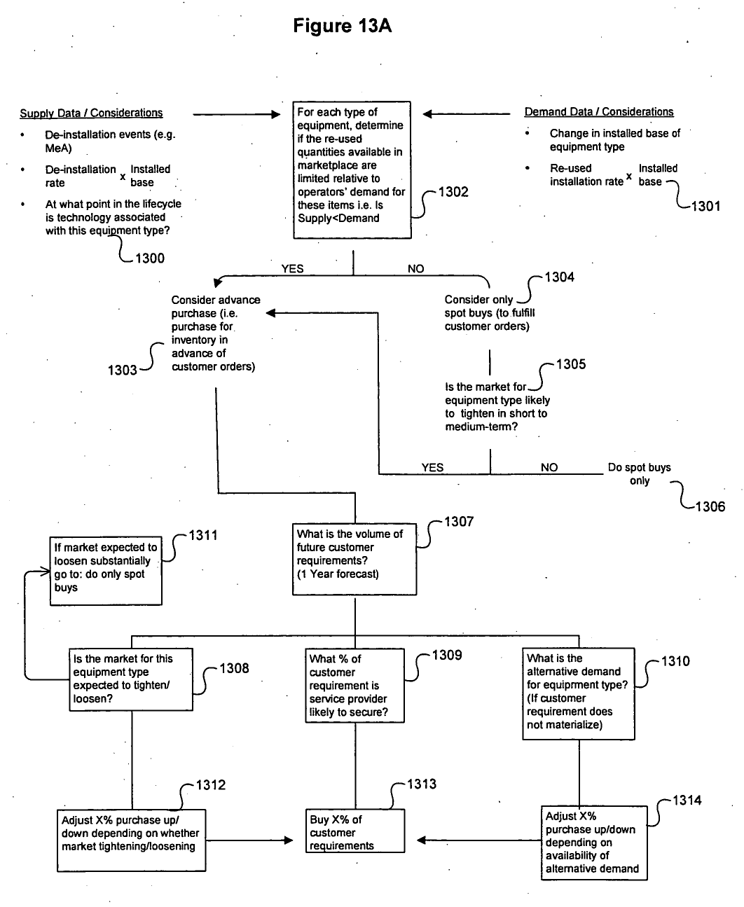

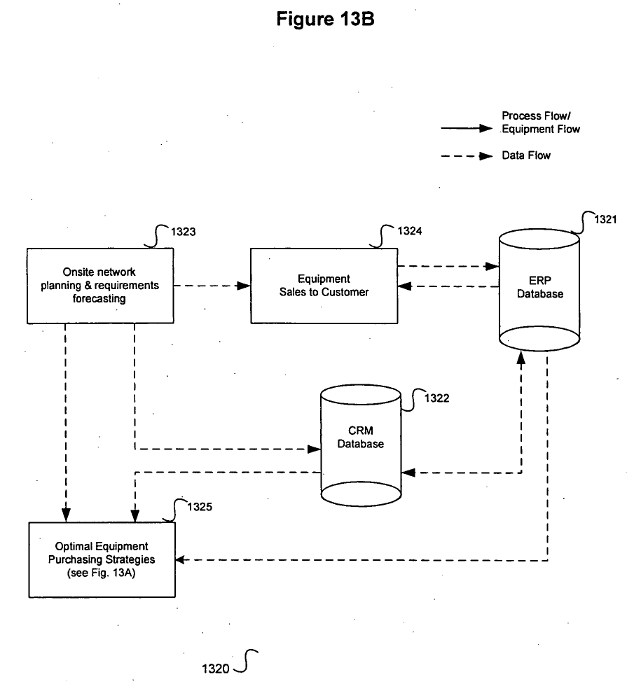

FIG. 13A is a flow diagram on the iterative process for optimizing re-used equipment purchases, according to an embodiment of the invention. The integrated suite of management processes and applications embodies, in the form of specific features of the detailed process logic and suggested information technology applications, an iterative process for optimizing re-used equipment purchases—including advance purchase based on entity-specific requirements forecasts; and the likelihood of alternative uses for the equipment (i.e. at other entities).

The iterative process for optimizing re-used equipment purchases, according to an embodiment includes analyzing the market for each equipment type (block 1302) and determining whether it is desirable for the service provider to consider advance purchases of an entity's re-used equipment requirements (i.e. purchasing for inventory in advance of equipment using entity orders) (block 1303) or whether the service provider should limit its risk and only fulfill equipment using entity orders for this equipment type through the spot market for re-used equipment (1304). In an embodiment, the analysis uses extensive data on the installed base of the equipment type at the major operators of telecommunications networks. This data is contained in the service provider's CRM database, which is most developed when the service provider gains onsite access to multiple entities and network operators.

The integrated suite of management processes and applications embodies procedures for the sale of telecommunications or other equipment items to the equipment using entity from the inventory of the service provider. In doing this, it makes use of both (i) the detailed knowledge of the equipment using entity's current and likely equipment requirements gained from systematic analysis of the network or other equipment population, and (ii) the equipment purchasing strategies shown in FIG. 13A to quickly and efficiently address the equipment using entity's need for renewing and maintenance of the network or other population of equipment than if such need were addressed by standalone purchases from the re-used equipment market.

This involves the service provider's personnel identifying a need for a particular item in collaboration with the equipment using entity's personnel and based on knowledge of the equipment using entity's needs gained through analysis of the equipment using entity's network or population of equipment. It may include identifying an opportunity to purchase an item through the re-used equipment market which is currently or has in the past been purchased new. If the item is available from the service provider's existing inventory, it may be immediately supplied to the equipment using entity, subject to pricing and other terms (for example, warranty) being accepted by the equipment using entity. Optimizing the equipment using entity's equipment purchases may include settling the payment for the item against trade credits earned from sale of goods to or through the service provider, and confirming, using the service provider's electronic records of the equipment using entity's deployed and spare equipment, that the item or an equivalent is not otherwise available in the equipment using entity's inventory. The processes also provide for taking account of any equivalences between different hierarchical levels of equipment, for example identifying components of the desired item which are in the equipment using entity's or service provider's inventory, or identifying items at a higher level of aggregation (assemblies of equipment) which contain the desired item and may be broken down to supply it. The use of ECS helps in identifying these equivalences.

If the item is not available in the service provider's own inventory, the service provider may make use of virtual inventory, which includes inventory held by reliable third parties in the secondary market for the required equipment. A systematic search of potential sources is used to obtain good pricing (and other terms, such as delivery and payment) on behalf of the equipment using entity, and may also be used just to identify a potential source for the item.

Having identified a source for the item, the service provider will ensure that the terms (principally price) on which the item is to be acquired are acceptable to the equipment using entity, and if they are, proceed to procure the item for shipment to the equipment using entity, executing further value-adding activities such as configuration, testing, and offering a warranty. The processes provide for capturing the monetary amount saved by procuring the item through the service provider as opposed to any other channel. This relates partially to the savings generated by procuring the item from the reused equipment market, but also to those gained by procuring the item through the service provider, who may be able to secure more favorable prices in that market than a large, well known communications network operator or other equipment using entity. Processes designed to verify that this is the case and report the savings to the equipment using entity are described as price check herein.

FIG. 13B is a data flow diagram showing databases of a system for managing equipment along with the flow of data between the databases for equipment purchasing, according to an embodiment of the invention. The system 1320 includes ERP database 1321 and CRM database 1322, as well as various logical elements represented by the other elements shown, which can be implemented in various combinations of hardware and software. These equipment purchasing strategies may use market intelligence collected during the service provider's review with the equipment using entity of its network planning and requirements forecasting (block 1323). This data is recorded in CRM database 1322 for each specific equipment using entity. The system may manage equipment sales to customers (block 1324). In addition, optimal equipment purchasing strategies (block 1325) use information regarding the inventory and the historical transactions recorded in ERP database 1321. Please refer to FIG. 13A for an elaboration of how this data is used in devising optimal equipment purchasing strategies.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory (such as electronically erasable programmable read only memory (EEPROM)), embedded microprocessors, firmware, software, etc. Furthermore, aspects of the systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, for example, metal-oxide semiconductor field-effect transistor (MOSFET) technologies like complementary metal-oxide semiconductor (CMOS), bipolar technologies like emitter-coupled logic (ECL), polymer technologies (for example, silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (for example, optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (for example, HTTP, FTP, SMTP, etc.). When received within a computer system via one or more computer-readable media, such data and/or instruction-based expressions of components and/or processes under the systems and methods may be processed by a processing entity (for example, one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods is recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. An electronic management system comprising:
a database having information regarding equipment held by a plurality of separately-owned equipment using entities;
logic that determines equipment held by a respective equipment using entity;
logic that stores the determined information regarding the equipment into the database; and
logic that determines whether respective items of equipment held by the equipment using entity should be retained or disposed of based on information in the database.

2. The electronic management system of claim 1, wherein the database includes information regarding equipment held by a service provider that operates the system.

3. The electronic management system of claim 1, wherein the database includes a first database having information regarding equipment held by a plurality of separately-owned equipment using entities and second database having information regarding equipment held by a service provider that operates the system.

4. The electronic management system of claim 3, wherein the first database comprises a customer relationship management (CRM) database.

5. The electronic management system of claim 3, wherein the second database comprises an enterprise resource planning (ERP) database.

6. The electronic management system of claim 3, wherein the information in the first database for respective equipment using entities is separated from information for other equipment using entities.

7. The electronic management system of claim 3, wherein the first database includes information regarding equipment purchases and sales by the respective equipment using entity.

8. The electronic management system of claim 3, wherein the first database includes information regarding forecasts of equipment requirements for spares and new builds for the respective equipment using entity.

9. The electronic management system of claim 3, wherein the first database includes identification of equipment identified as a result of determining equipment held by the entity.

10. The electronic management system of claim 9, wherein the first database includes manufacturer identification codes of the equipment identified.

11. The electronic management system of claim 3, wherein the first database includes results of equipment valuations for the respective equipment using entity.

12. The electronic management system of claim 9, including logic that finds equipment for sale by the service provider from information in the first database regarding equipment identified as a result of determination of equipment held by the entity.

13. The electronic management system of claim 3, wherein the information in the second database regarding equipment held by a service provider that operates the system includes information regarding equipment owned by the service provider and information regarding equipment held on consignment by the service provider.

14. The electronic management system of claim 13, wherein the information in the second database includes manufacturer part number and condition of respective equipment.

15. The electronic management system of claim 13, wherein the information in the second database includes information regarding sales made by the service provider.

16. The electronic management system of claim 1, including logic that values the equipment based on information regarding history of the equipment stored in the database.

17. The electronic management system of claim 1, including logic that, if an item of equipment is determined to be disposed of, determines a value of the item of equipment based on information from multiple ones of the equipment using entities stored in the database and generates an offer to dispose of the item of equipment.

18. The electronic management system of claim 17, wherein the offer is to dispose of the item of equipment through a set of services including:
purchasing the item of equipment from the entity, the price based on the determined value;
offering the item of equipment for sale through consignment; or
scrapping the item of equipment.

19. The electronic management system of claim 1, wherein the logic that determines equipment held by a respective equipment using entity receives information obtained through visiting premises of the equipment using entity and reviewing equipment held by the entity during the visit.

20. The electronic management system of claim 1, wherein the logic that determines equipment held by a respective equipment using entity receives information regarding the equipment from a database maintained by the respective equipment using entity.

21. The electronic management system of claim 1, including logic that:
receives information regarding the equipment from a database maintained by the respective equipment using entity; and
reconciles information received from the entity with information received from the database maintained by the respective equipment using entity.

22. The electronic management system of claim 1, including logic that determines equivalency of items of equipment held by the respective equipment using entity to other items of equipment.

23. The electronic management system of claim 22, wherein the other items of equipment are other items of equipment held by the equipment using entity.

24. The electronic management system of claim 22, wherein the other items of equipment are components of larger items of equipment.

25. The electronic management system of claim 22, wherein the other items of equipment are combinations of separate items of equipment.

26. The electronic management system of claim 22, wherein the other items of equipment are designated with different codes.

27. The electronic management system of claim 22, including a matrix of equivalency between different codes used for equivalent items of equipment, and logic that uses the matrix to determine the equivalency of the items of equipment held by the respective equipment-using entity to the other items of equipment.

28. The electronic management system of claim 1, including:
logic that identifies in the database items of equipment from among equipment held by other equipment using entities, and
identifies potential offers to provide additional equipment needed by the equipment using entity from among the identified items of equipment.

29. The electronic management system of claim 1, including logic that generates reports for the equipment using entity of financial results of outsourced management of procurement, deployment and disposition of the equipment held by the equipment using entity.

30. The electronic management system of claim 1, wherein the equipment comprises telecommunication equipment.

31. The electronic management system of claim 1, wherein the logic comprises software.

32. The electronic management system of claim 1, wherein the logic comprises a software and hardware.
